(19) United States
(12) Patent Application Publication
(10) Pub. No.: US 2019/0385111 A1
(43) Pub. Date: Dec. 19, 2019

(54) SYSTEM AND METHOD FOR PROVIDING PERFORMANCE EVALUATION

(71) Applicant: Anthony Piccolo, Southlake, TX (US)

(72) Inventor: Anthony Piccolo, Southlake, TX (US)

(21) Appl. No.: 16/010,914

(22) Filed: Jun. 18, 2018

(51) Int. Cl. G06Q 10/06; H04L 29/06

(52) U.S. Cl. CPC G06Q 10/06398; H04L 63/105; H04L 63/083

(57) ABSTRACT

The present invention discloses a system and method to evaluate performance and provide objective feedback based on factors that are created, valued, and prioritized by a client company. The present invention comprises a first user device, a performance evaluation system, network and a second user device. The performance evaluation system comprises a server having a processor and a memory unit. The performance evaluation server is configured to enables a user to choose a key performance indicators or factors that the client company want to be scored within their organization. The first user device enables an employee to access the performance evaluation system to view scorecard and manage user profile of the first user. The second user device enables an administrator to access the performance evaluation system to manage the scorecard of the first user.

### BACKGROUND OF THE INVENTION

### A. Technical Field

The present invention generally relates to a system and method for providing performance evaluation. More specifically, the present invention relates to a system and method to evaluate performance and provide objective feedback based on factors that are created, valued, and prioritized by a client company.

### B. Description of Related Art

Performance evaluation is an important organizational component that impacts many aspects of management and its workforce (e.g., pay, promotion, accountability, retention, training, etc.). Performance evaluation is a core component of human resources management because it satisfies both organizational and individual needs. As organizations and corporate culture continue to change and expand, performance evaluation systems have not adapted to meet such changes and expansion.

Typically, a company's evaluation policy calls for periodic evaluations (often annual or biannual). These evaluations often consist of a manager writing out an evaluation, holding a brief counseling session with the employee, and then forwarding the forms to the human resources department. Some managers are more motivated than others to provide constructive and meaningful feedback, but there is no efficient way for the human resources department to supervise the feedback quality. As a result, the quality of feedback that employees receive often varies greatly. Because the process is so decentralized, it is very difficult to effectively disseminate company-wide performance goals, or to consistently evaluate the results achieved. Additionally, because the person evaluating an employee may change periodically, it is difficult to track an employee's long-term success at meeting goals.

Conventional rating systems are often at a very high level of granularity. For example, many organizations provide nothing more than a set of generic ratings for employees for individual categories encapsulated by terms such as “meets expectations,” “exceeds expectations,” or “needs improvements. An organization might have 60% of the employee ratings in the middle positions, but still need to understand how people are ranked within that group. Further, these does not allow to measure performance of company's multiple layers and individual who excels in each layer or provide performance measure of group of employees to identify relative performance.

Therefore, there is a need for a system and method to evaluate performance and provide objective feedback on based on factors that are created, valued, and prioritized by a client company. Further, there is a need for the system and method that enables to optimize the company's human capital, measure performance of each layer and roles of the company. Further, there is a need for the system and method that enables to identify individual who excels in each layer or provide performance measure of group of employees to identify relative performance.

### SUMMARY OF THE INVENTION

The present invention discloses a system and method to evaluate performance and provide objective feedback based on factors that are created, valued, and prioritized by a client company. The system enables to choose a key performance indicators or factors that the client company want to be scored within their organization. The system further enables to optimize company human capital and measure performance of various layers and roles of company that are all interdependent while interconnected.

The present invention comprises a first user device, a performance evaluation system, a network, a database and a second user device. The performance evaluation system comprises a server having a processor and a memory unit. The performance evaluation server is configured to evaluate performance and provide objective feedback based on factors that are created, valued, and prioritized by a client company. The first user device is enabled to access the performance evaluation system to view scorecard and manage profile of the first user. The second user device is enabled to access the performance evaluation system by a second user to manage the scorecard of the first user. The memory unit comprises a set of program modules, which includes login module, factor management module, employee management module, company factorcard module, company scorecard module, employee scorecard module, profile management module, company role management module, and factor management module.

The login module, executed by the processor, configured to generate a user account by providing relevant information identifying the user and the user account. In an embodiment, the user is an employee or administrator. The factor management module, executed by the processor, configured to allow the administrator to add an employee data and respective key performance factor data to evaluate performance, wherein the key performance factor data comprises factor type, scorecard type, factor value.

The employee management module, executed by the processor, configured to allow the administrator to view and manage profile of each employee of the company. The company factorcard module, executed by the processor, configured to display and download each employee data and key performance factor data of the respective employee data. The company scorecard module, executed by the processor, configured to display and download score data for each key performance factor of each employee, wherein the score data comprises employee name, total factor scores and type of total score. The employee scorecard module, executed by the processor, configured to display score data of the employee. The profile management module, executed by the processor, configured to allow the employee or administrator to customize the employee profile.

In one embodiment, a method for evaluating performance is disclosed. At one step, an administrator is enabled to add an employee data and respective key performance factor data to evaluate performance, at a processor, via a factor management module. The key performance factor data comprises factor type, scorecard type, factor value and score. At another step, the administrator is enabled to view and manage profile of each employee of the company, at a processor, via an employee management module. At another step, each employee data and key performance factor data of the respective employee data is displayed and could be downloaded, at the processor, via a company factorcard module. At another step, score data for each key performance factor of the employee is displayed and could be downloaded, at the processor, via a company scorecard module. The score data comprises employee name, total factor scores and type of total score. At another step, score data of the employee is displayed, at the processor via an employee scorecard module. At another step, the employee or administrator is enabled to customize the employee profile at the processor, via a profile management module.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates an environment implemented in accordance with various embodiments of the invention.

FIG. 2A exemplarily illustrates a block diagram of a performance evaluation server in an embodiment of the present invention.

FIG. 2B is a flowchart illustrating a method for evaluating performance, according to an embodiment of the present invention.

FIG. 3 exemplarily illustrates a screenshot of login page, according to an embodiment of the present invention

FIG. 4 exemplarily illustrates a screenshot displaying scorecard of the user, according to an embodiment of the present invention.

FIG. 5 exemplarily illustrates a screenshot to add new factors and score, according to an embodiment of the present invention.

FIG. 6 exemplarily illustrates a screenshot displaying the user profile, according to an embodiment of the present invention.

FIG. 7 exemplarily illustrates a screenshot of updating profile picture of the user, according to an embodiment of the present invention.

FIG. 8 exemplarily illustrates a screenshot of employee management page that allows administrators to view and edit all employees' personal information of the company, according to embodiment of the present invention.

FIG. 9 exemplarily illustrates a screenshot to add new employee information, according to an embodiment of the preset invention.

FIG. 10 exemplarily illustrates a screenshot of displaying fields to add employee information according to an embodiment of the preset invention.

FIG. 11 exemplarily illustrates a screenshot for bulk upload of employee details, according to an embodiment of the present invention.

FIG. 12 exemplarily illustrates a screenshot of labelling of census, according to an embodiment of the present invention.

FIG. 13 exemplarily illustrates a screenshot of displaying a list of company roles, according to an embodiment of the present invention.

FIG. 14 exemplarily illustrates a screenshot of creating new company role, according to an embodiment of the present invention.

FIG. 15 exemplarily illustrates a screenshot of editing company roles, according to an embodiment of the present invention.

FIG. 16 exemplarily illustrates a screenshot displaying a list of company factors, according to an embodiment of the present invention.

FIG. 17 exemplarily illustrates, a screenshot of creating new company factor, according to an embodiment of the present invention.

FIG. 18 exemplarily illustrates a screenshot of editing company factor, according to an embodiment of the present invention.

FIG. 19 exemplarily illustrates a screenshot of company factorcard page showing inputted scores, according to an embodiment of the present invention.

FIG. 20 exemplarily illustrates a screenshot of company scorecard page, according to an embodiment of the present invention.

FIG. 21 exemplarily illustrates a screenshot of company score in the form of bar chart graph, according to an embodiment of the present invention.

FIG. 22 exemplarily illustrates a screenshot of performance level of employee in the form of bar chart graph, according to an embodiment of the present invention.

FIG. 23 exemplarily illustrates a screenshot of top performers of the company in the form of bar chart graph, according to an embodiment of the present invention.

FIG. 24 exemplarily illustrates a screenshot of medium performers of the company in the form of bar chart graph, according to an embodiment of the present invention.

FIG. 25 exemplarily illustrates a screenshot of bottom performers of the company in the form of bar chart graph, according to an embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

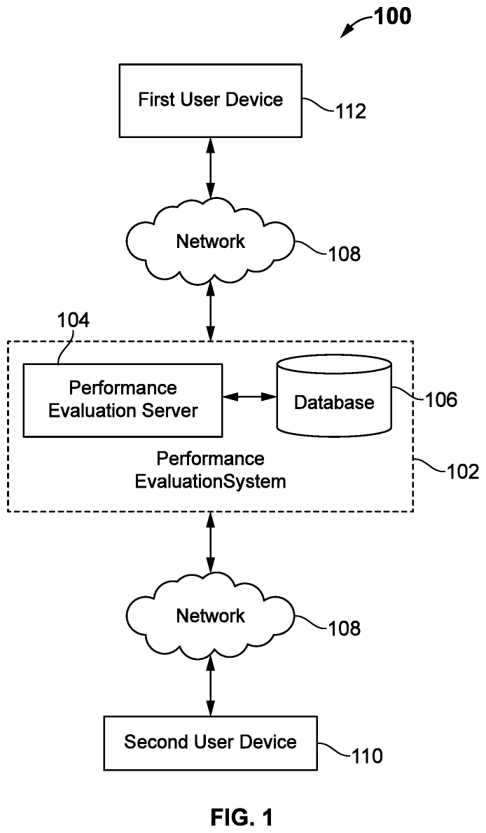

The present invention discloses a system and method to evaluate performance and provide objective feedback based on factors that are created, valued, and prioritized by a client company. The system enables to choose a key performance indicators or factors that the client company want to be scored within their organization. The system further enables company to optimize their human capital, measure various layers and roles of company that are all interdependent while interconnected. Referring to FIG. 1, a block diagram of an environment 100 implemented in accordance with various embodiments of the present invention is disclosed. The environment 100 comprises a first user device 112, a performance evaluation system 102, a network 108 and a second user device 110. In an embodiment, the performance evaluation system 102 comprises a performance evaluation server 104 and at least one database 106.

In an embodiment, the first user device 112 is enabled to access the performance evaluation system 102 to view scorecard and manage profile of the first user. In an embodiment, the second user device 110 is enabled to access the performance evaluation system 102 by a second user to manage the scorecard of the first user. In an embodiment, the first user is an employee. In another embodiment, the second user is an administrator. In another embodiment, the second user is an authorized employee to manage the scorecard of the first user.

The performance evaluation server 104 is configured to evaluate performance and provide objective feedback based on factors that are created, valued, and prioritized by a client company. In an embodiment, the first user device 112 is at least one of a desktop, a laptop, a tablet, a mobile phone, and mobile and/or handheld electronic devices. In an embodiment, the second user device 110 is at least one of a desktop, a laptop, a tablet, a mobile phone, mobile and/or handheld electronic devices. In an embodiment, the first user device 112 and the second user device 110 are in communication with the network 108 to access the performance evaluation server. In an embodiment, the network 108 could be Wi-Fi network, WiMax network, and wireless local area network.

In an embodiment, the at least one database 106 may be accessible by the performance evaluation server. In an embodiment, the at least one database 106 may be integrated into the performance evaluation server or separate from it. In an embodiment, the database 106 resides in a connected server or in a cloud computing service. In an embodiment, regardless of location, the databases 106 comprise a memory to store and organize certain data for use by the performance evaluation server. In some embodiments, the at least one database stores user account information, scorecard information, factor type, scorecard type, factor value and score of all employees of the company.

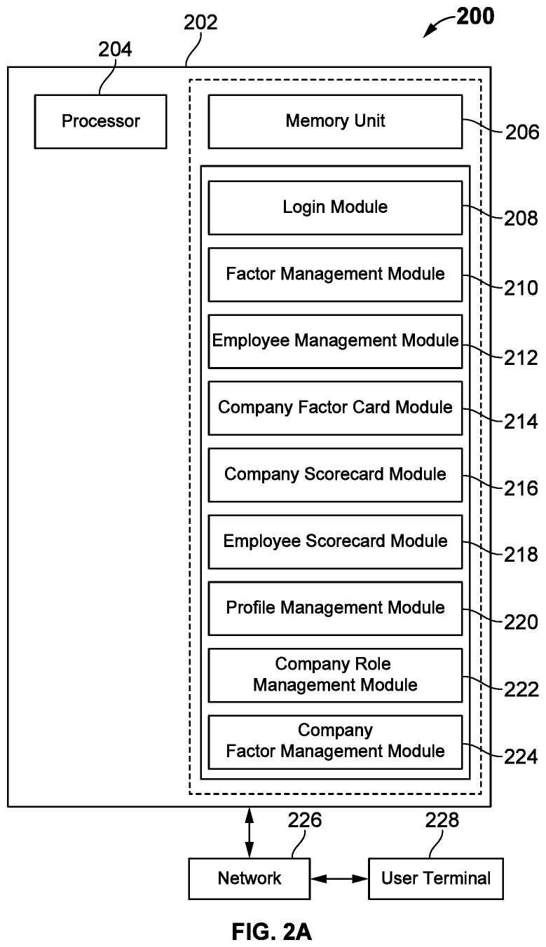

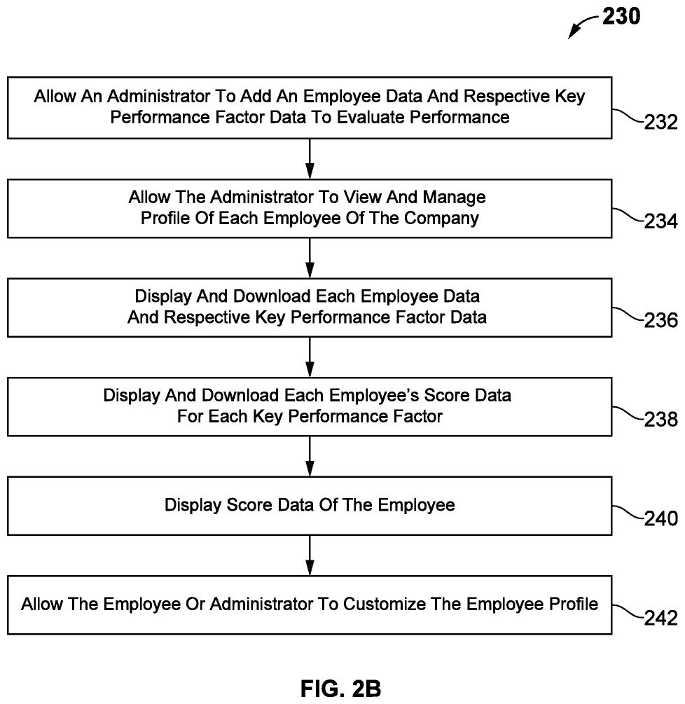

In an embodiment, the performance evaluation server 104 is at least one of a general or special purpose computer. In an embodiment, it operates as a single computer, which can be a hardware and/or software server, a workstation, a desktop, a laptop, a tablet, a mobile phone, a mainframe, a supercomputer, a server farm, and so forth. In an embodiment, the computer can be touchscreen and/or non-touchscreen and can run on any type of OS, such as iOS™, Windows™, Android™, Unix™, Linux™ and/or others. In an embodiment, the computer is in communication with networks. Such communication can be via a software application, a mobile app, a browser, an OS, and/or any combination thereof. Further, a block diagram 200 of an exemplary implementation of the server 104 is illustrated in FIG. 2A.

FIG. 2A is a block diagram 200 of a performance evaluation server 202 in an embodiment of the present invention. The server 202 comprises a processor 204 and a memory unit 206. The memory unit 206 comprises a set of program modules comprises login module 208, factor management module 210, employee management module 212, company factorcard module 214, company scorecard module 216, employee scorecard module 218, profile management module 220, company role management module 222, and factor management module 224. In an embodiment, the user access server 202 via a user terminal 228 via a network 226. In an embodiment, the network 226 is at least anyone of a Wi-Fi network, WiMax network, and wireless local area network. In an embodiment, the user terminal 228 is at least anyone of a desktop, a laptop, a tablet, a mobile phone, mobile and/or handheld electronic devices, personnel digital assistants, smart phones, smart televisions, palm tops and phablets.

The server 202 is configured to identify company's key performance factors and separates them into scorecards, thereby making it easy to score and keep track of all the employee's performance. The factor is an objective, which the company finds value in measuring. For example, in a plumbing company, sales marketing such as getting new business, meeting sales call goal, sales goal; operations such as getting to work on time, having the right equipment, involving at clients, check-in process, adding parts receipts to service tickets, recalls; accounting such as billing on time, billed accurately, collect on time, review billing portals daily, make deposit; management such as show up on time, leave early, no call no show, customer complaint, customer compliment and safety such as wear seat belt, use cell phone, get a ticket, car wreck are considered as the key performance factors.

The login module 208, executed by the processor 204, configured to generate a user account by providing relevant information identifying the user and the user account. In an embodiment, the user is an employee or administrator. The factor management module 210, executed by the processor 204, configured to allow the administrator to add an employee data and respective key performance factor data to evaluate performance, wherein the key performance factor data comprises factor type, scorecard type, factor value. On adding the employee data such as employee name, selecting the scorecard type, selecting the factor to score the employee on, and the factor value would auto appear. Further, after adding the above data, the score is added. In one embodiment, notes could be added along with the employee data.

The employee management module 212, executed by the processor 204, configured to allow the administrator to view and manage profile of each employee of the company. The company factorcard module 214, executed by the processor 204, configured to display and download each employee data and key performance factor data of the respective employee data. In one embodiment, the company factorcard module 214 configured to display inputted scores of each employee. In another embodiment, the company factorcard module 214 enables to manage the displayed data such as allows to sort from most recent, employee name, scorecard type, factor name, factor value, or date range. In yet another embodiment, the company factorcard module 214 enables to export the displayed data by making a copy, saving it as an CSV, exporting it to Excel, saving as a PDF, or could be printed it out.

The company scorecard module 216, executed by the processor 204, is configured to display and download score data for each key performance factor of each employee, wherein the score data comprises employee name, total factor scores and type of total score. In one embodiment, the company scorecard module 216 is configured to provide complete list of employees in the company and their factor scores. Further, enables to sort scorecards by employee name, scorecard name, who reports to whom, total factor score, or type of total score. In another embodiment, the company scorecard module 216 enables to export scorecards by making a copy, saving it as an CSV, exporting it to Excel, saving as a PDF, or printing it out. In another embodiment, the company scorecard module 216 provides a company drilldown option. The drilldown option allows companies to view their overall company score (a summation of all scores in the company during a chosen period), their employees' performance level, and the employees ranking within their performance level, in a bar chart.

The employee scorecard module 218, executed by the processor 204, is configured to display score data of the employee. In one embodiment, the employee scorecard module 218 allows employees to see their scores for each factor they are being scored on, as well as their total relative score i.e., a curved score against all other employees. The employees total relative score is a curved score, so that the new employees and employees who have worked for the company for years could be evaluated fairly. Each employee scorecard comprises a colored circular chart on which the employee could scroll over each color of the circle to see score for each factor. The profile management module 220, executed by the processor 204, configured to allow the employee or administrator to customize the employee profile.

The company role management module 222, executed by the processor 204, enables the administrator to create and manage company roles. The company factor management module 224, executed by the processor 204, enables the administrator to add and manage key performance factor

Referring to FIG. 2B, a method 230 for evaluating performance is disclosed. At step 232, an administrator is enabled to add an employee data and respective key performance factor data to evaluate performance, at a processor, via a factor management module. The key performance factor data comprises factor type, scorecard type, factor value and score. At step 234, the administrator is enabled to view and manage profile of each employee of the company, at a processor, via an employee management module. At step 236, each employee data and key performance factor data of the respective employee data is displayed and could be downloaded, at the processor, via a company factorcard module. At step 238, score data for each key performance factor of the employee is displayed and could be downloaded, at the processor, via a company scorecard module. The score data comprises employee name, total factor scores and type of total score. At step 240, score data of the employee is displayed, at the processor via an employee scorecard module. At step 242, the employee or administrator is enabled to customize the employee profile at the processor, via a profile management module.

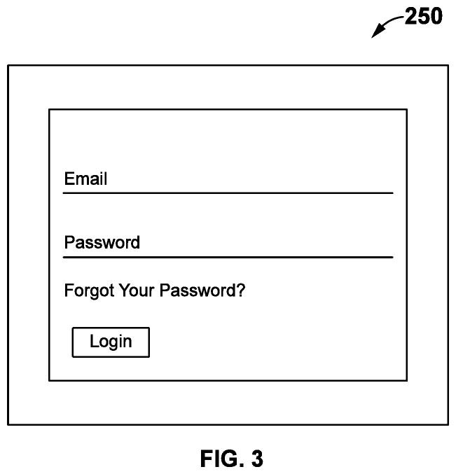

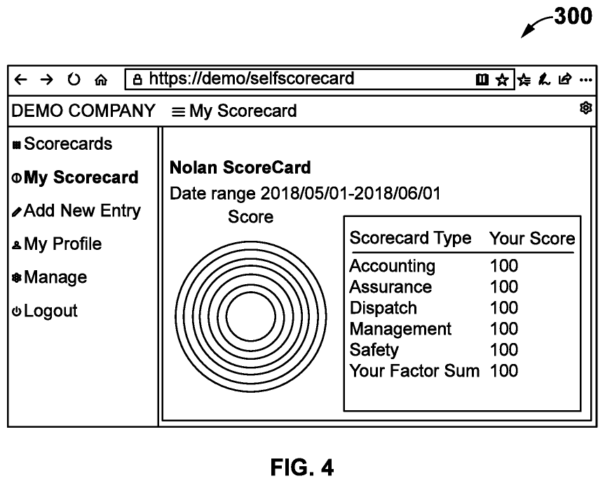

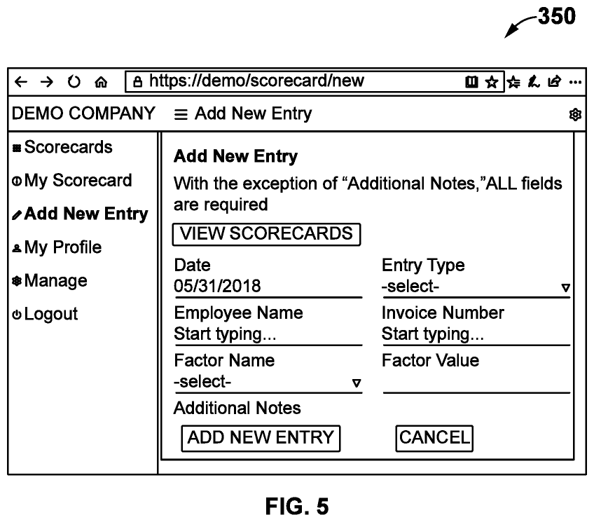

Referring to FIG. 3, a screenshot 250 of login page, according to an embodiment of the present invention is disclosed. The login page allows a user to create account or enter login information such as login ID or password to access respective user account. Referring to FIG. 4, a screenshot 300 displaying scorecard of the user, according to an embodiment of the present invention is disclosed. Further, allows the user to see their scores for each factors and factor sum score. Referring to FIG. 5, a screenshot 350 to add new factors and score, according to an embodiment of the present invention is disclosed. On selecting the “add new entry” option, fields for adding entry type, employee name, invoice number, factor name, factor value and notes are displayed. Further, on submission of the filled data, score is added.

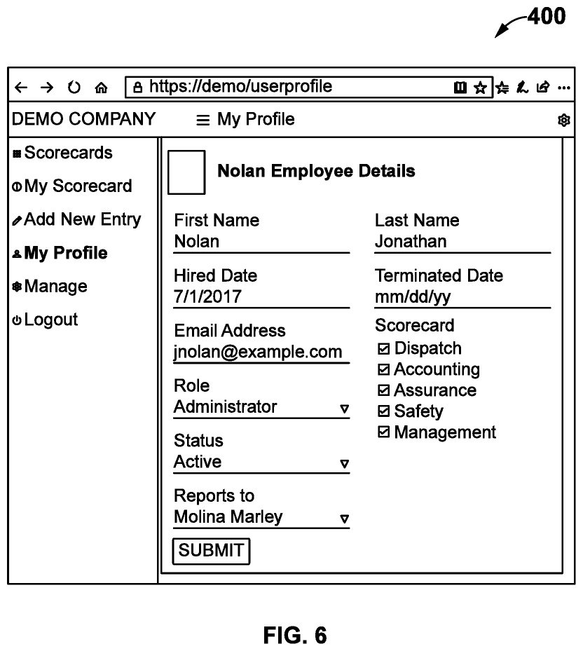

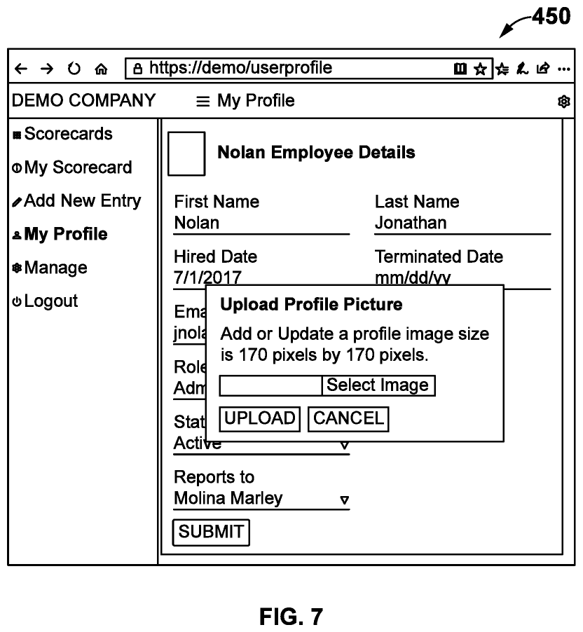

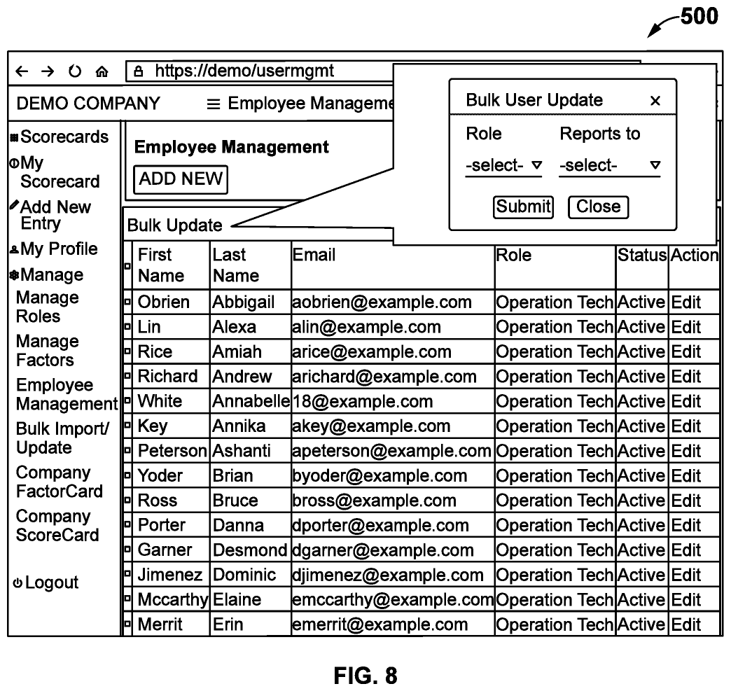

Referring to FIG. 6, a screenshot 400 displaying the user profile, according to one embodiment of the present invention is disclosed. The user is prohibited to change any of their profile information. Referring to FIG. 7, a screenshot 450 of updating profile picture of the user, according to an embodiment of the present invention is disclosed. The user is enabled to change his picture by clicking on his current picture and selecting an image from the user device. Referring to FIG. 8, a screenshot 500 of employee management page that allows administrators to view and edit all employees' personal information of the company, according to embodiment of the present invention. Further, this page enables bulk update by selecting employees' role and who the employee need to report.

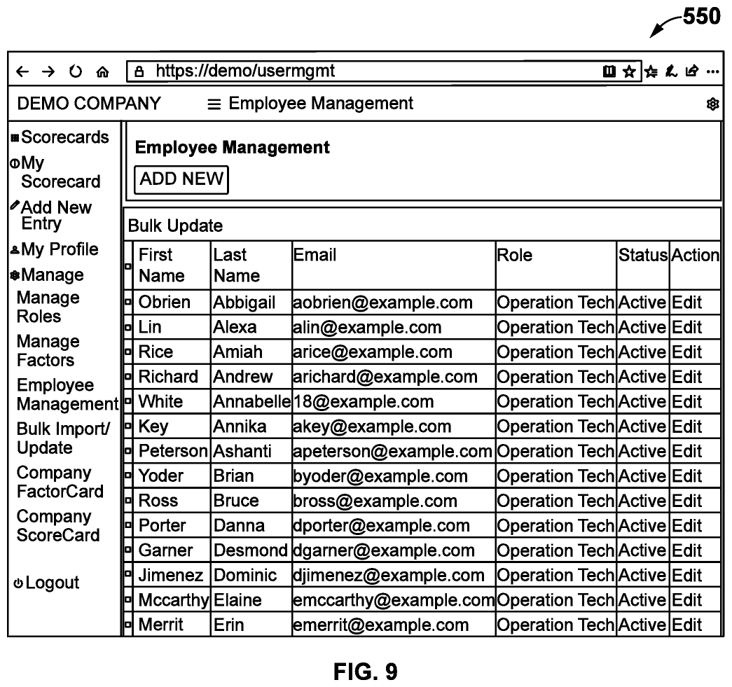

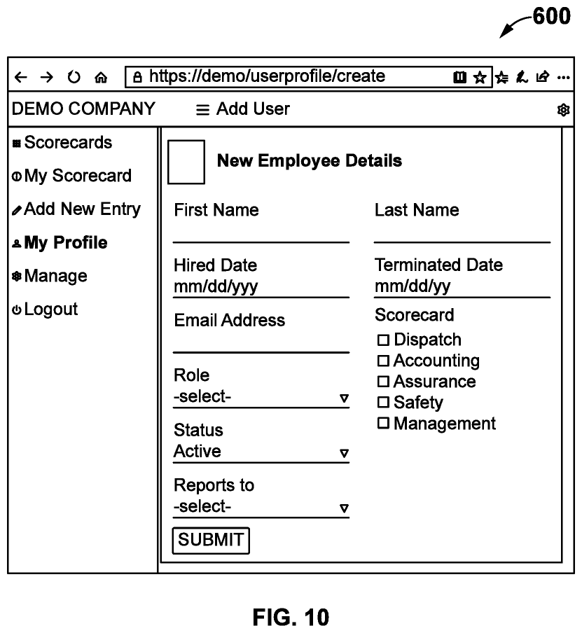

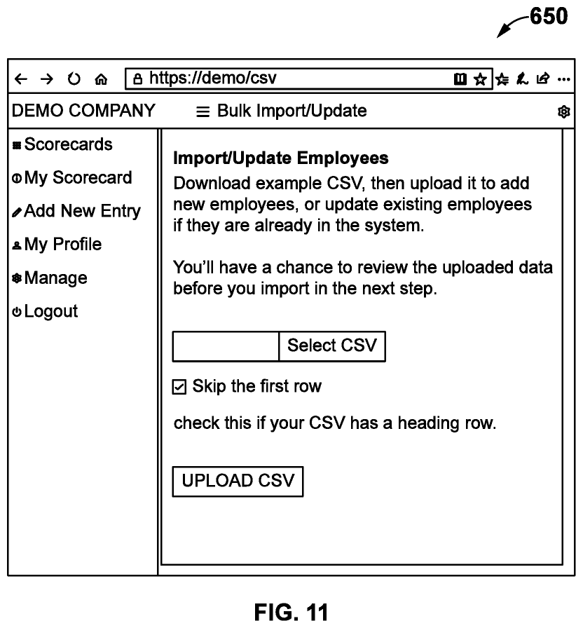

Referring to FIG. 9, a screenshot 550 comprising an “add new” option to add new employee information according to an embodiment of the preset invention is disclosed. Referring to FIG. 10, a screenshot 600 displaying fields to add employee information, on selecting “add new” option, according to an embodiment of the present invention is disclosed. In one embodiment, the employee information includes name, email, role, status, reports to and scorecards. Referring to FIG. 11, a screenshot 650 of bulk upload of employee details, according to an embodiment of the present invention is disclosed. The user need to select bulk import/update from manage option and click on select CSV and upload company census.

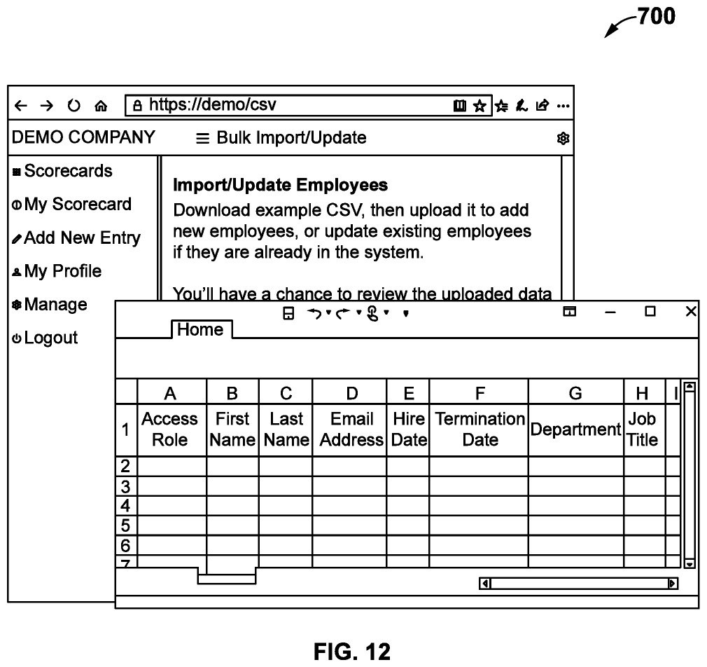

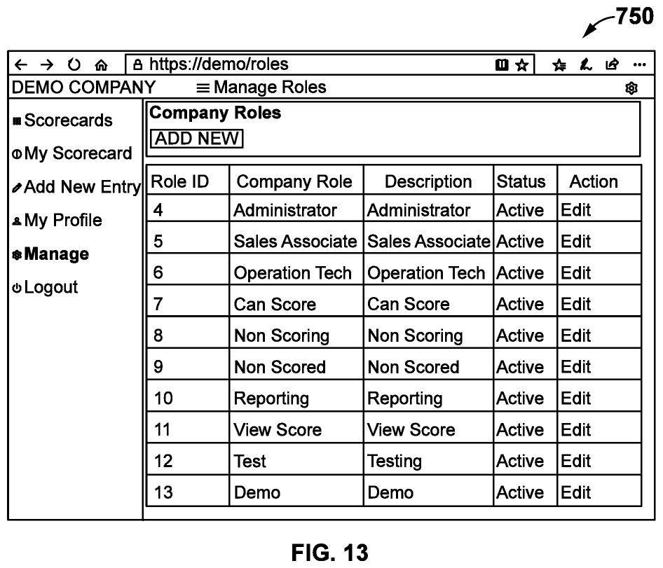

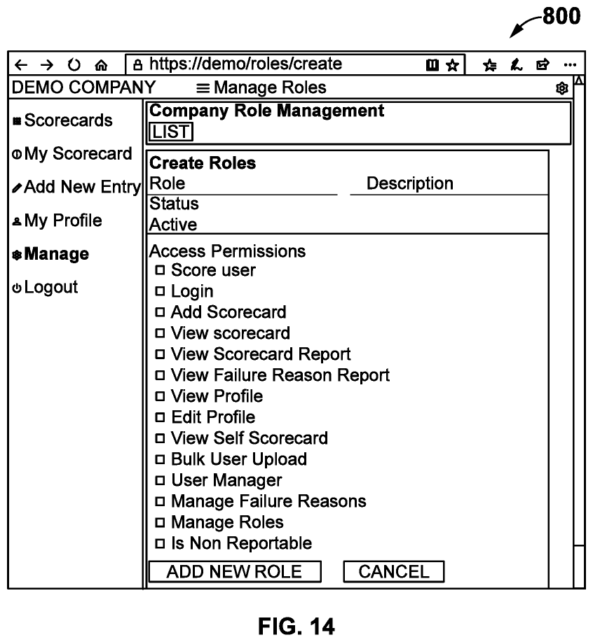

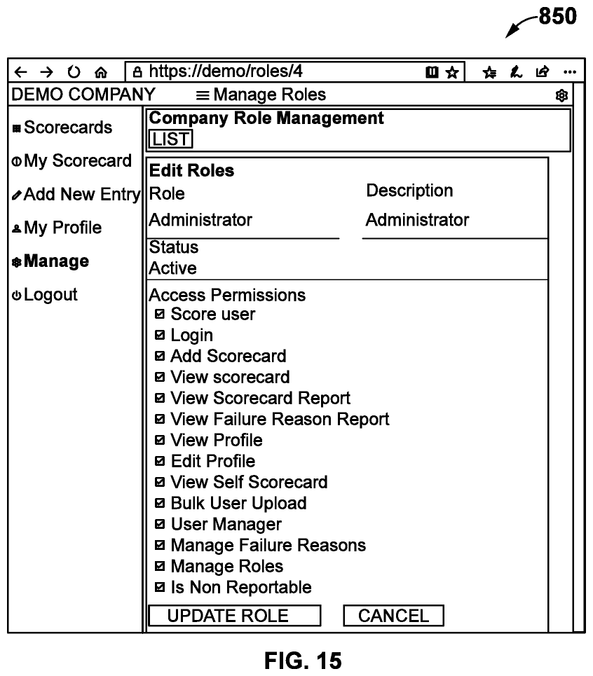

Referring to FIG. 12, a screenshot 700 of labelling of census, according to an embodiment of the present invention is disclosed. Referring to FIG. 13, a screenshot 750 displaying a list of company roles and the access provided within performance scoring, according to an embodiment of the present invention, is disclosed. Referring to FIG. 14, a screenshot 800 of creating new company role by adding role name, department, active/inactive status, and select access permissions for the role is disclosed, according to an embodiment of the present invention. Referring to FIG. 15, a screenshot 850 of editing company roles is disclosed, according to an embodiment of the present invention. To edit roles, “edit” option need to be selected and the user need to edit the information needs to be changed. Later, “update role” option is need to be selected to save the changes.

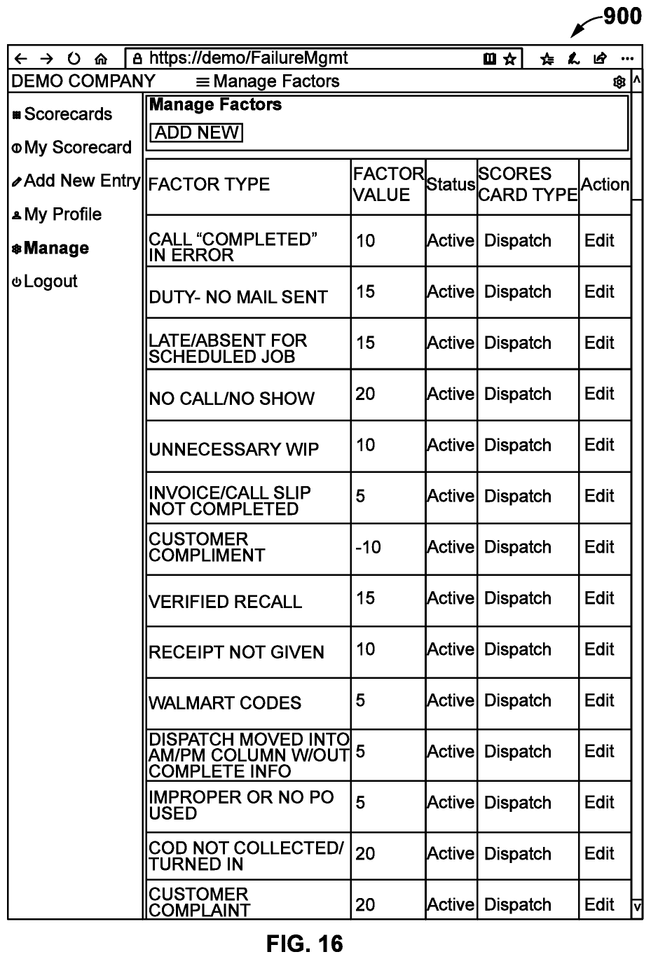

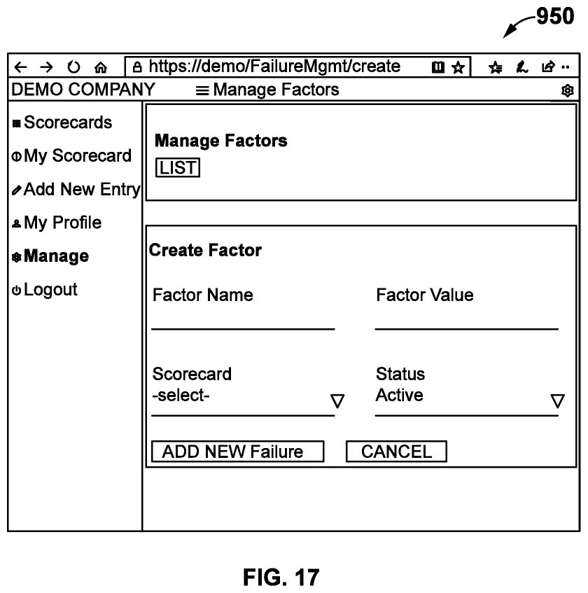

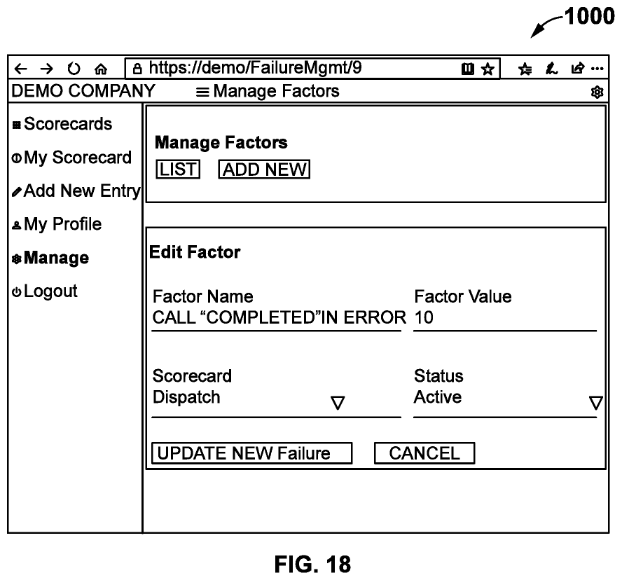

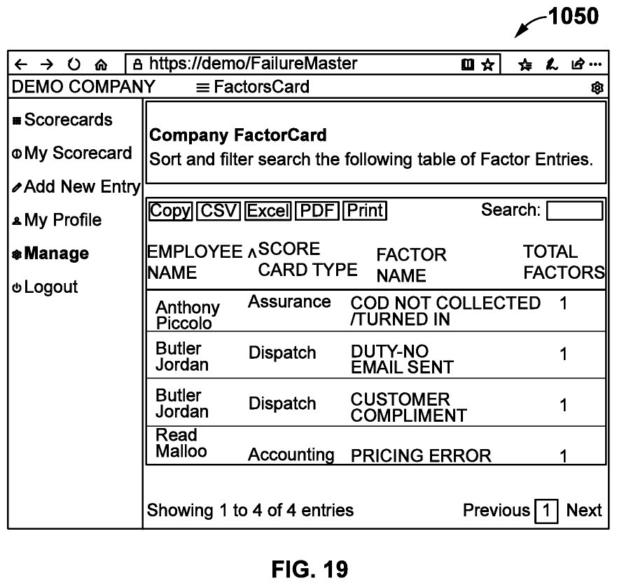

Referring to FIG. 16, a screenshot 900 displaying a list of company factors, according to an embodiment of the present invention. Referring to FIG. 17, a screenshot 950 of creating new company factor by adding factor name, factor value, scorecard, and active/inactive is disclosed, according to an embodiment of the present invention. Referring to FIG. 18, a screenshot 1000 of editing company factor is disclosed, according to an embodiment of the present invention. Referring to FIG. 19, a screenshot 1050 of company factorcard page showing inputted scores is disclosed, according to an embodiment of the present invention. Further, company factorcard page comprising employee name, scorecard type, factor name or factor value could be sorted and could be exported by making a copy, saving it as an CSV, exporting it to Excel, saving as a PDF, or printing it out.

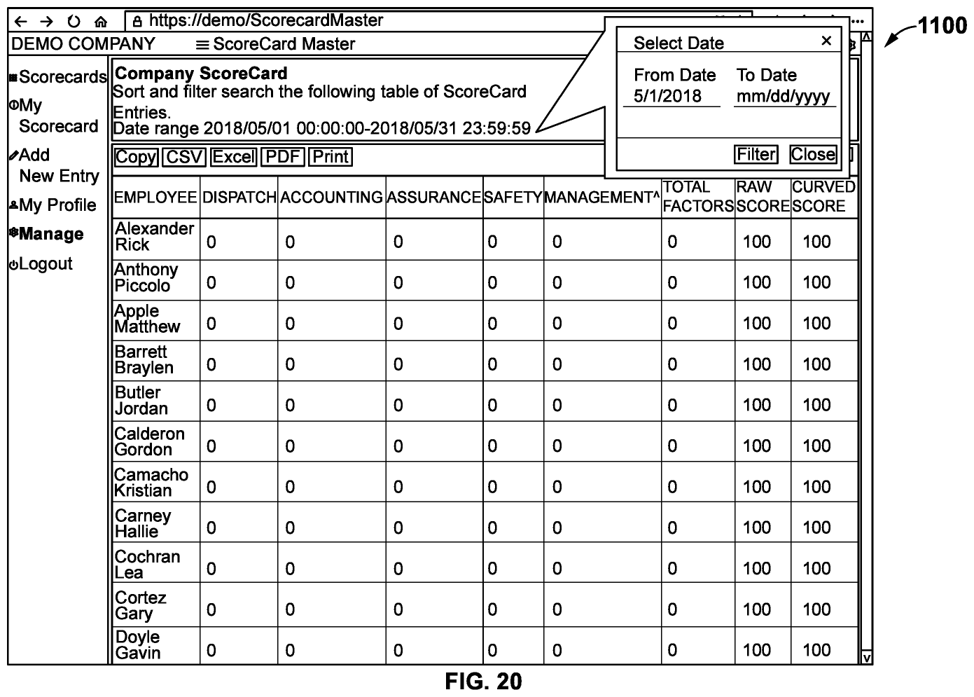

Referring to FIG. 20, a screenshot 1100 of company scorecard page, according to an embodiment of the present invention. Further, company scorecard page provides option to search scorecard by date range and to export scorecard page by making a copy, saving it as an CSV, exporting it to Excel, saving as a PDF, or printing it out.

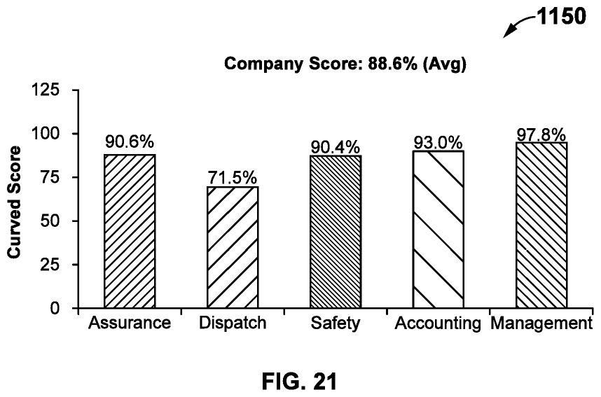

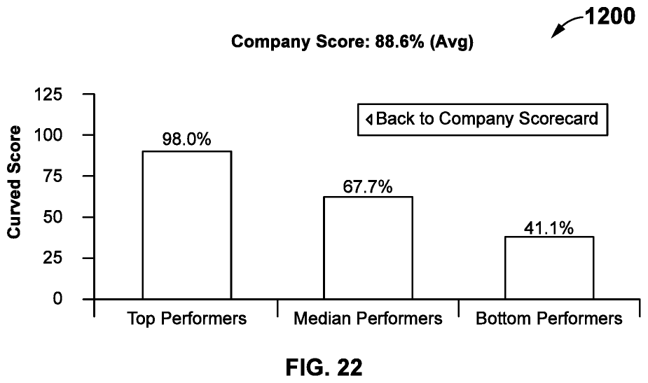

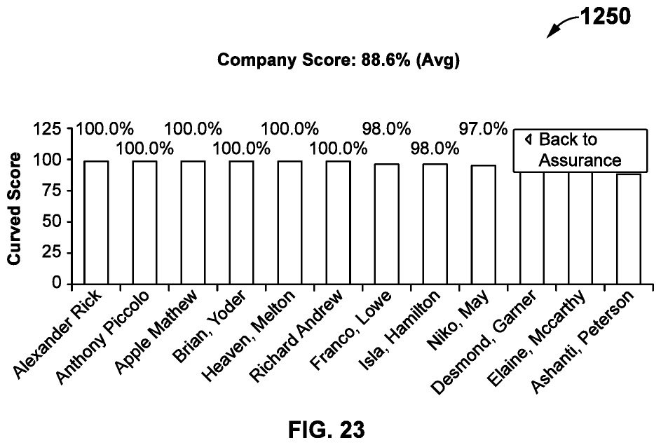

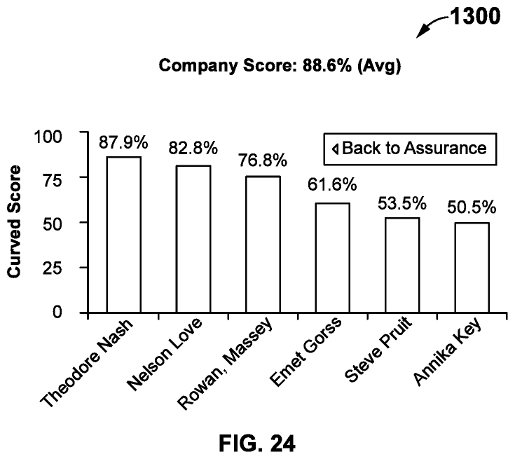

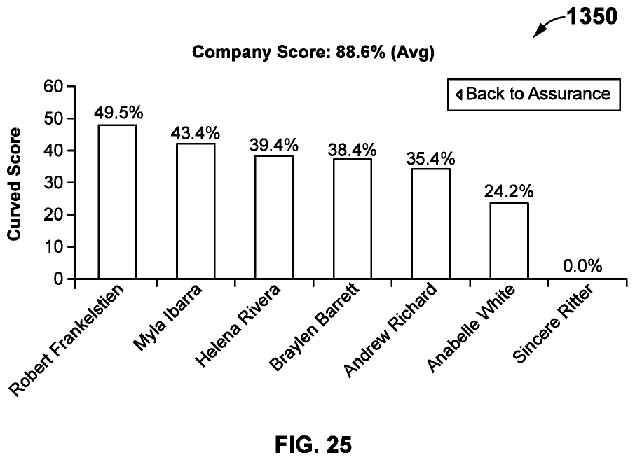

FIG. 21 exemplarily illustrates a screenshot 1150 of company score in the form of bar chart graph, according to an embodiment of the present invention. FIG. 22 exemplarily illustrates a screenshot 1200 of performance level of employee in the form of bar chart graph, according to an embodiment of the present invention. FIG. 23 exemplarily illustrates a screenshot 1250 of top performers of the company in the form of bar chart graph, according to an embodiment of the present invention. FIG. 24 exemplarily illustrates a screenshot 1300 of medium performers of the company in the form of bar chart graph, according to an embodiment of the present invention. FIG. 25 exemplarily illustrates a screenshot 1350 of bottom performers of the company in the form of bar chart graph, according to an embodiment of the present invention.

Advantageously, performance evaluation system of the present invention keeps track of who can score, cannot score, cannot be scored and manage functions such as manage roles, manage factors, bulk import/update, company factorcard, and company scorecards. The system could also change personal information by creating the employees based on company role. Company roles are determined when inputting employees but can be edited at any time. The system enables the companies to provide access to the employees, administration, or managers as much or little access permission to performance scoring as they see fit, or it is custom built to their company. Performance Scoring has an employee management page, which allows administrators or employees to view all the company's employees as well as edit their personal information. Bulk updates to employees can also be made by selecting their role and whom they report.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A performance evaluation system, comprising:
a server comprising a processor and a memory unit;
a database in communication with the server for storing plurality of user account information;
a first device associated with an employee to access the server via a network; and
a second device associated with an administrator to access the server via the network,
wherein the memory unit stores a set of program modules, and
wherein the processor in communication with the memory unit, configured to execute the set of program modules, wherein the set of program modules comprises,
a factor management module configured to allow the administrator to add an employee data and respective key performance factor data to evaluate performance, wherein the key performance factor data comprises factor type, scorecard type, factor value and score,
an employee management module configured to allow the administrator to view and manage profile of each employee of the company,
a company factorcard module configured to display and download each employee data and key performance factor data of the respective employee data,
a company scorecard module configured to display and download score data for each key performance factor, wherein the score data comprises employee name, total factor scores and type of total score,
employee scorecard module configured to display score data of the employee, and
a profile management module configured to allows the employee or administrator to customize the employee profile.

2. The system of claim 1, wherein the set of program modules further comprises a login module configured to allow the employee to login by providing relevant employee information to identify the employee.

3. The system of claim 1, wherein the login module configured to allow the administrator to login by providing relevant administrator information to identify the administrator.

4. The system of claim 1, wherein the set of program modules further comprises a company role management module enables the administrator to create and manage company roles.

5. The system of claim 1, wherein the set of program modules further comprises a company factor management module enables the administrator to add and manage key performance factor.

6. The system of claim 1, wherein the administrator is an authorized employee.

7. The system of claim 1, wherein the first user device is at least one of a tablet computer, personnel computer, personnel digital assistant, smart phone, smart television, palm top, phablet, laptop, or a device with computational capability connected to the internet.

8. The system of claim 1, wherein the second user device is at least one of a tablet computer, personnel computer, personnel digital assistant, smart phone, smart television, palm top, phablet, laptop, or a device with computational capability connected to the internet.

9. The system of claim 1, wherein the memory unit is at least one of a volatile memory, non-volatile memory, read only memory (ROM), random access memory (RAM), and a flash memory.

10. The system of claim 1, wherein the network is at least one of a Local Area Network, a Wide Area Network, a Wireless Network, a telecommunication network, a mobile network, and an Internet.

11. A performance evaluation method, comprising steps of:
allowing at a processor, via a factor management module, the administrator to add an employee data and respective key performance factor data to evaluate performance, wherein the key performance factor data comprises factor type, scorecard type, factor value and score;
allowing at a processor, via an employee management module, the administrator to view and manage profile of each employee of the company;
displaying and downloading at the processor, via a company factorcard module, each employee data and key performance factor data of the respective employee data;
displaying and downloading at the processor, via a company scorecard module, score data for each key performance factor, wherein the score data comprises employee name, total factor scores and type of total score;
displaying, at the processor via an employee scorecard module score data of the employee; and
allowing at the processor, via a profile management module, the employee or administrator to customize the employee profile.

12. The method of claim 11, further comprises a step of allowing at the processor via a login module, the employee to login by providing relevant employee information to identify the employee.

13. The method of claim 11, further comprises a step of allowing at the processor via a login module, the administrator to login by providing relevant administrator information to identify the administrator.

14. The method of claim 11, further comprises a step of enabling at the processor, via a company role management module, the administrator to create and manage company roles

15. The method of claim 11, further comprises a step of enabling at the processor, via a company factor management module, the administrator to add and manage key performance factor

16. The method of claim 11, wherein the administrator is an authorized employee.
